(19) United States
(12) Patent Application Publication
(10) Pub. No.: US 2025/0243633 A1
(43) Pub. Date: Jul. 31, 2025

(54) Slipform paver

(71) Applicant: Wirtgen GmbH, Windhagen (DE)

(72) Inventors: Philip Verhaelen, Lohmar (DE); Michael Engels, Montabaur (DE); Kevin Schenkelberg, Hartenfels (DE)

(21) Appl. No.: 19/033,696

(22) Filed: Jan. 22, 2025

(30) Foreign Application Priority Data
Jan. 26, 2024 (DE) 10 2024 102 291.4

(51) Int. Cl. E01C 19/48

(52) U.S. Cl. CPC E01C 19/4893

(57) ABSTRACT

A slipform paver includes a machine frame, at least three travelling devices connected to the machine frame, and at least one belt conveyor device pivotable relative to the machine frame about an essentially horizontal axis and about an essentially vertical axis. The belt conveyor device includes a first end and a second end, a belt conveyor base and a belt conveyor arranged on said belt conveyor base, wherein the belt conveyor revolves around a first return roller and a second return roller. A first actuator is configured such that the belt conveyor device is pivotable about the essentially horizontal axis. A second actuator is configured such that the belt conveyor device is pivotable about the essentially vertical axis. An adjustment device is configured such that the first and second ends of the belt conveyor device are adjustable in the longitudinal direction of the belt conveyor device.

### RELATED APPLICATIONS

The present application claims priority to German Patent Application Ser. No. 10 2024 102 291.4 filed Jan. 26, 2024, which is incorporated herein by reference.

### BACKGROUND OF THE DISCLOSURE

### Field of the Disclosure

The disclosure relates to a slipform paver, and to a method for the construction of ground pavements or structures by means of slipform pavers.

### Description of the Prior Art

Slipform pavers, such as known, for example, from DE 199 57 048 (U.S. Pat. No. 6,481,924), generally comprise a machine frame, travelling devices that are connected to said machine frame, as well as at least one belt conveyor device. The belt conveyor device enables materials such as concrete to be transported to a working device. The working device enables the creation of ground pavements or structures. The working device may be, for example, a concrete mold, and may be both exchangeable as well as alterable in position or extendable. Furthermore, the travelling devices are generally connected to the machine frame in such a manner that they can alter their position relative to the machine frame.

The at least one belt conveyor device may be connected to the machine frame in such a manner that the belt conveyor device is pivotable, relative to the machine frame, at least about an essentially horizontal axis and at least about an essentially vertical axis. The belt conveyor device may comprise at least one first end and at least one second end, wherein the belt conveyor device comprises at least one belt conveyor base and at least one belt conveyor arranged on said belt conveyor base, wherein the belt conveyor revolves around at least one first return roller on the first end of the belt conveyor device, and at least around one second return roller on a second end of the belt conveyor device. At least one first actuator may be arranged and designed in such a manner that the belt conveyor device is pivotable at least about the essentially horizontal axis, and at least one second actuator may be arranged and designed in such a manner that the belt conveyor device is pivotable at least about the essentially vertical axis.

The belt conveyor device may comprise a material reception area for the reception of concrete. The concrete is then transported, via the belt conveyor device, to the working device, in particular to the concrete mold, which is used to construct the ground pavement or structure.

With the known slipform pavers, there is frequently the problem that the position of the material reception area and/or the position of the working device changes or that the working device itself is exchanged. There is thus an increasing requirement to simplify the operation of the conveying device.

### SUMMARY OF THE DISCLOSURE

It is therefore the object of the present disclosure to create a slipform paver and a method for the construction of ground pavements or structures by means of slipform pavers that simplify the operation of the entire slipform paver, in particular the operation of the conveying device.

The present disclosure advantageously provides that at least one adjustment device is provided, which is designed in such a manner that the first and second ends of the belt conveyor device may be adjusted in the longitudinal direction of the belt conveyor device.

The adjustment device may thus adjust both the first as well as the second end of the belt conveyor device. This does not mean that both the first and second ends of the conveyor belt device are always adjusted. Depending on the application, the adjustment device may adjust only the first end or the second end or both ends. In the process, the adjustment operation may be performed simultaneously or also successively.

The longitudinal direction of the belt conveyor device corresponds to the longitudinal direction of the belt conveyor. The longitudinal direction of the belt conveyor device, or the longitudinal direction of the belt conveyor, extends preferably parallel to the transport direction of the belt conveyor device.

The present disclosure therefore has the advantage that the belt conveyor device can be adapted very well to the environment and the application. It may be necessary to adjust the position of the material reception area, in particular if the material must be applied in different places due to different requirements. Likewise, it is possible that the position of the working device changes or that the exchange of the working device requires repositioning of the conveying device, respectively. This adaptability makes the belt conveyor device particularly flexible in its application.

The adjustment device may be designed in such a manner that the first and second ends may be adjusted independently of each other in the longitudinal direction of the belt conveyor device.

The first and second ends may, for example, be adjusted in different directions or also be adjusted by different amounts in the same direction.

The adjustment device may be designed in such a manner that the belt conveyor base, and therefore the belt conveyor device, is adjustable in the longitudinal direction of the belt conveyor device relative to the machine frame, and that the spacing between the first return roller on the first end of the belt conveyor device and the second return roller on the second end of the belt conveyor device is adjustable.

Adjusting the belt conveyor base enables the entire belt conveyor device to be adjusted in the longitudinal direction of the belt conveyor device relative to the machine frame.

Adjusting the spacing between the first return roller on the first end of the belt conveyor device and the second return roller on the second end of the belt conveyor device allows the transport length of the belt conveyor to be adjusted.

The adjustment device may be designed in such a manner that it enables both the adjustment of the belt conveyor base and the adjustment of the transport length of the belt conveyor. This does not mean that both must always be adjusted. Under certain conditions, only the belt conveyor base may be adjusted, or the belt conveyor length.

On the other hand, both may also be adjusted simultaneously or successively.

The adjustment device may be designed in such a manner that the first and/or the second return roller is adjustable relative to the belt conveyor base, so that the spacing between the first return roller on the first end of the belt conveyor device and/or the second return roller on the second end of the belt conveyor device is adjustable.

The adjustment device may comprise at least one first adjustment actuator and at least one second adjustment actuator.

The first adjustment actuator may be arranged and designed in such a manner that the belt conveyor base, and therefore the belt conveyor device, is adjustable in the longitudinal direction of the belt conveyor device relative to the machine frame by means of the first adjustment actuator. The second adjustment actuator may be arranged and designed in such a manner that the spacing between the first return roller on the first end of the belt conveyor device and the second return roller on the second end of the belt conveyor device is adjustable by means of the second adjustment actuator.

The belt conveyor base may thus be adjusted by means of the first adjustment actuator. The length of the belt conveyor may be adjusted by means of the second adjustment actuator.

Alternatively, it may also be provided that the belt conveyor base is not designed to be adjustable but that the first adjustment actuator adjusts the first return roller relative to the belt conveyor base and the second adjustment actuator adjusts the second return roller relative to the belt conveyor base. This allows the spacing between the first and second return rollers to be adjusted, or the first and second return rollers may be adjusted by the same amounts in the same direction.

In a further alternative, the adjustment device may also comprise only one adjustment actuator. In this case, the belt conveyor base could first be adjusted by means of the adjustment actuator. To this end, the possibility of adjusting the spacing between the first and second return rollers could be locked, and only the belt conveyor base could be adjusted by means of the adjustment device. The belt conveyor base could then be locked relative to the machine frame and, with the belt conveyor base locked, the one actuator of the adjustment device could be then used to only adjust at least one return roller. This would also enable both adjustment operations to be performed with only one adjustment actuator, namely, on the one hand, the adjustment of the belt conveyor base relative to the machine frame and, on the other hand, the adjustment of the spacing between the first and second return rollers.

At least two first adjustment actuators and/or at least two second adjustment actuators may also be provided.

It may be advantageous to provide at least two adjustment actuators, for example, if the two adjustment actuators are provided on the sides of the belt conveyor so that the force is evenly distributed and jamming does not occur during the adjustment of the belt conveyor device.

The second adjustment actuator may be arranged and designed in such a manner that the first and/or the second return roller is adjustable relative to the belt conveyor base, so that the spacing between the first return roller on the first end of the belt conveyor device and the second return roller on the second end of the belt conveyor device is adjustable.

The second adjustment actuator may therefore be arranged and designed in such a manner that the first and/or second return roller is adjustable relative to the belt conveyor base, so that the length of the belt conveyor is adjustable.

The at least one return roller may be driven, so that the return roller may drive the revolving belt conveyor. In addition to the first and second return rollers, at least one third and one fourth return roller may be provided around which the belt conveyor runs, wherein at least the third return roller may be adjustable in such a manner that the belt conveyor always exhibits a predetermined tension even when adjusting the spacing between the first return roller and the second return roller. The predetermined tension is preferably a tension at which the function of the belt conveyor is guaranteed. Furthermore, instead of the at least one first and/or the at least one second return rollers, the third and/or fourth return rollers may additionally or alternatively be driven.

In this design, the third return roller may be adjusted by the same spacing as the first or second return roller. If the first and second return rollers are adjusted simultaneously, the third return roller is preferably adjusted by the amount by which the spacing between the first and second return rollers changes. The third return roller is always adjusted in such a manner that the tension of the belt conveyor preferably remains essentially the same.

The maximum spacing between the first and second return rollers may be 130% to 200%, preferably 140% to 160%, in relation to the minimum spacing between the first and second return rollers.

The maximum transport length of the belt conveyor device may therefore be between 130% to 200%, preferably 140% to 160%, in relation to the minimum transport length of the belt conveyor device.

The at least one belt conveyor device may be adjustable in height relative to the machine frame along an essentially vertical axis.

This has the advantage that the belt conveyor device can be adjusted even more flexibly.

The at least one belt conveyor device may be movable in a horizontal plane relative to the machine frame, preferably by means of a parallelogram guide.

The belt conveyor may comprise an upper run and a lower run. The upper run may also be termed load run. This is the upper part of the belt conveyor, on which the material to be transported lies. It moves from the loading point to the unloading point and carries the load of the material. The upper run is preferably supported by a series of supporting surfaces or bearing surfaces, which ensure that the belt does not sag under the load of the material. Alternatively, the belt conveyor may also be supported by supporting rollers in lieu of supporting surfaces.

The lower run, which is also termed empty run, is the lower part of the belt conveyor, which runs back to the loading point after the material has been discharged. It carries no load other than the belt's own weight and any remnants of transported material that have not been discharged. The at least one third and at least one fourth return rollers are preferably arranged on the lower run.

According to the present disclosure, a method may be provided for the construction of ground pavements or structures by means of a slipform paver, which comprises at least one machine frame, to which at least one belt conveyor device is connected, wherein the belt conveyor device is pivotable, relative to the machine frame, at least about an essentially horizontal axis and at least about an essentially vertical axis, wherein the belt conveyor device comprises at least one first end and at least one second end. The belt conveyor device comprises at least one belt conveyor base and at least one belt conveyor arranged on the belt conveyor base, wherein the belt conveyor may revolve at least around one first return roller on the first end of the belt conveyor device and at least around a second return roller on the second end of the belt conveyor device, wherein at least one first actuator may pivot the belt conveyor device at least about the horizontal axis, wherein at least one second actuator may pivot the belt conveyor device at least about a vertical axis. It is advantageously provided that the first and second ends of the belt conveyor device may be adjusted in the longitudinal direction of the belt conveyor by means of an adjustment device.

The first and second ends may be adjusted independently of each other in the longitudinal direction of the belt conveyor device by means of the adjustment device.

The first and second ends may be adjusted simultaneously or successively.

### BRIEF DESCRIPTION OF THE DRAWINGS

In the following, one embodiment of the present disclosure is explained in more detail with reference to the drawings.

The following is shown schematically:

FIG. 1 a top view of a slipform paver,

FIG. 2 a perspective view of a belt conveyor device,

FIG. 3 a side view of the belt conveyor device according to FIG. 2,

FIG. 4. the belt conveyor device according to FIG. 3 with adjusted belt conveyor base,

FIG. 5 the belt conveyor device with extended transport length of the belt conveyor,

FIG. 6a-6b adjustment of the belt conveyor of the belt conveyor device,

FIG. 7 alternative to FIG. 5,

FIG. 8 further alternative to FIGS. 5 and 6,

FIG. 9 a view of the suspension of the belt conveyor device from below,

FIG. 10 a view of the suspension of the belt conveyor device according to FIG. 4 in top view, and

FIG. 11 a perspective view of the belt conveyor device,

FIG. 12 the embodiment according to FIG. 11 without belt conveyor.

### DETAILED DESCRIPTION

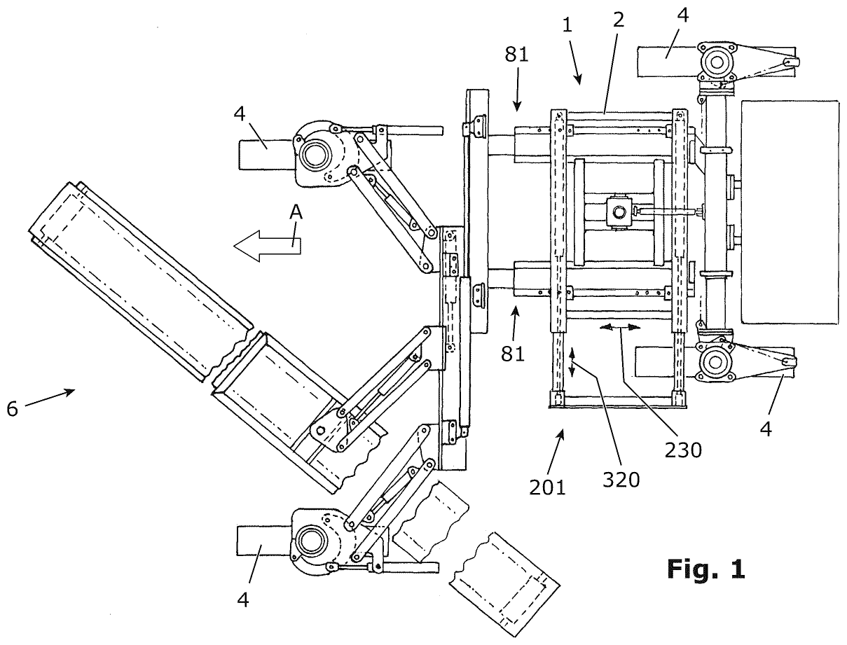

FIG. 1 shows a slipform paver 1. A slipform paver can be used to construct ground pavements or structures. The slipform paver 1 can move in the direction of operation A.

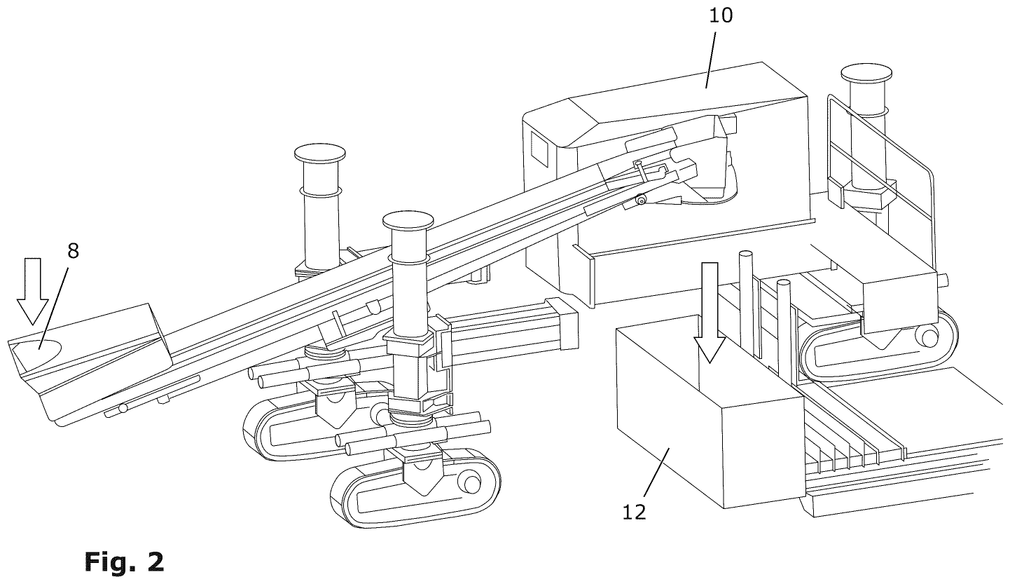

The slipform paver 1 comprises at least one machine frame 2. Travelling devices 4 are connected to the machine frame 2. Furthermore, at least one belt conveyor device 6 is provided. The belt conveyor device 6 may be used, for example, to transport concrete to a working device 12 (FIG. 2). The working device can be used to construct ground pavements or structures. The working device may, for example, be a concrete mold. The working device may be exchangeable and may also be alterable in position, or it may additionally or alternatively be extended. The travelling devices 4 may be connected to the machine frame in such a manner that they may alter their position relative to the machine frame.

A slipform paver 1 is depicted in FIG. 1, in which the longitudinal members 81 of the machine frame 2 are variable in length. Furthermore, the machine frame 2 also comprises a machine frame part 201, which is variable in length in the longitudinal direction 230 and in the transverse direction 320. Different working devices 12, for example, concrete molds of different shapes, may be attached to said machine frame part 201. These may be positioned differently relative to the ground-engaging units 4 and in particular relative to the belt conveyor device 6 by means of the machine frame part 201.

Material may be picked up by means of the belt conveyor device 6 and conveyed into the working device 12, which is used to construct the pavement or structures.

In FIG. 2, the belt conveyor device 6 is depicted in more detail, in which the material is picked up at the material reception 8 and is placed in the working device 12 designed as a concrete mold at the point 10.

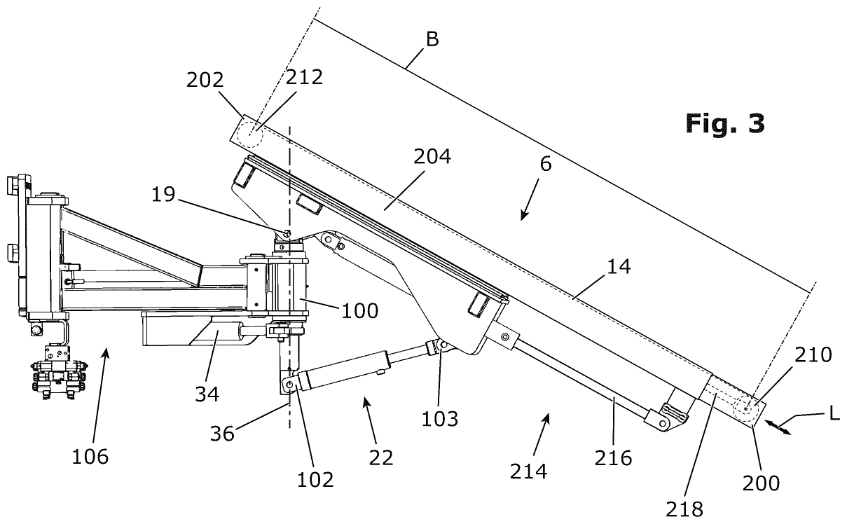

The belt conveyor device 6 is depicted in greater detail in FIG. 3. The belt conveyor device 6 comprises a belt conveyor 14, which is shown in FIG. 3. The belt conveyor 14, and therefore the belt conveyor device 6, may be pivoted about an essentially horizontal pivoting axis 19 by means of at least one first actuator 22.

Furthermore, the conveying device 6 may be pivoted about an essentially vertical pivoting axis 36 by means of a second actuator 34. The pivoting axis 19 is preferably arranged below the belt conveyor 14. As depicted in the embodiment, the pivoting axis 19 may be arranged in the upper third of the conveying device 6. In a further preferred embodiment, the pivoting axis 19 may be arranged in the area of the middle third of the conveying device 6. In the embodiment depicted, the depicted first actuator 22 is mounted on a connection element 100 to pivot about a pivoting axis 102. The connection element 100 is arranged on a parallelogram guide 106. The first actuator 22 is furthermore mounted on a second end to also pivot about a pivoting axis 103. The belt conveyor device 6 may also be movable in height translationally along the essentially vertical axis 36 either manually or by means of an additional actuator.

The belt conveyor device comprises at least one first end 200 and a second end 202. The belt conveyor device 6 furthermore comprises at least one belt conveyor base 204 and at least the belt conveyor 14 arranged on the belt conveyor base 204. The belt conveyor 14 runs around at least one first return roller 210 on the first end 200 of the belt conveyor device 6, and at least around a second return roller 212 on the second end 202 of the belt conveyor device 6. At least one adjustment device 214 is provided, which is designed in such a manner that the first and second ends 200, 202 of the belt conveyor device 6 are adjustable in the longitudinal direction L of the belt conveyor device 6. The longitudinal direction of the belt conveyor device 6 is also the longitudinal direction L of the belt conveyor 14.

The first and second ends 200, 202 may be adjustable independently of each other in the longitudinal direction L of the belt conveyor device 6.

The adjustment device 214 may be designed in such a manner that, on the one hand, the belt conveyor base 204 and therefore the belt conveyor device 6 is adjustable in the longitudinal direction L of the belt conveyor device 6 relative to the machine frame 2, and that, on the other hand, the spacing B between the first return roller 210 and the second return roller 212 is adjustable. Adjustment of the spacing between the first return roller 210 and the second return roller 212 enables the length of the transport length of the belt conveyor 14 to be adjusted.

In the embodiment depicted, the adjustment device 214 may comprise a first adjustment actuator 216 and at least one second adjustment actuator 218.

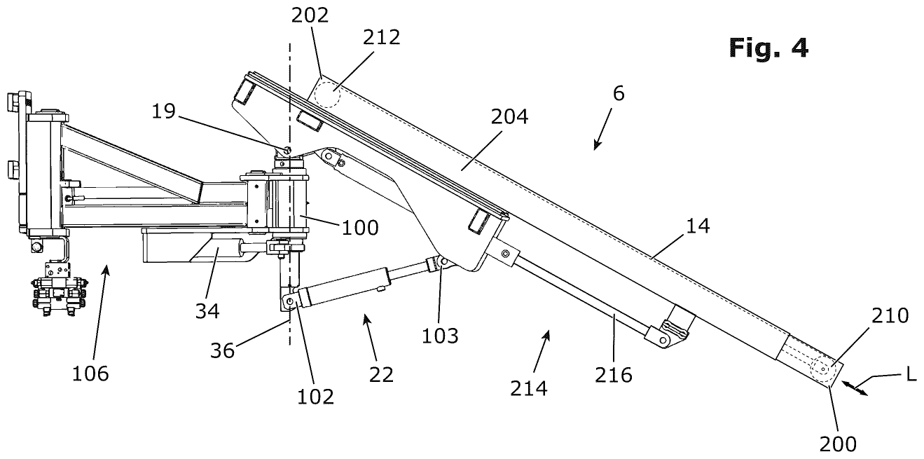

The first adjustment actuator 216 may be arranged and designed in such a manner that the belt conveyor base 204, and therefore the belt conveyor device 6, is adjustable in the longitudinal direction L of the belt conveyor device 6 relative to the machine frame 2 by means of the first adjustment actuator 216. FIG. 4 depicts the embodiment according to FIG. 3, in which the belt conveyor base 204 and therefore the belt conveyor device 6 has been adjusted in the longitudinal direction L of the belt conveyor device 6 relative to the machine frame 2 by means of the first adjustment actuator 216.

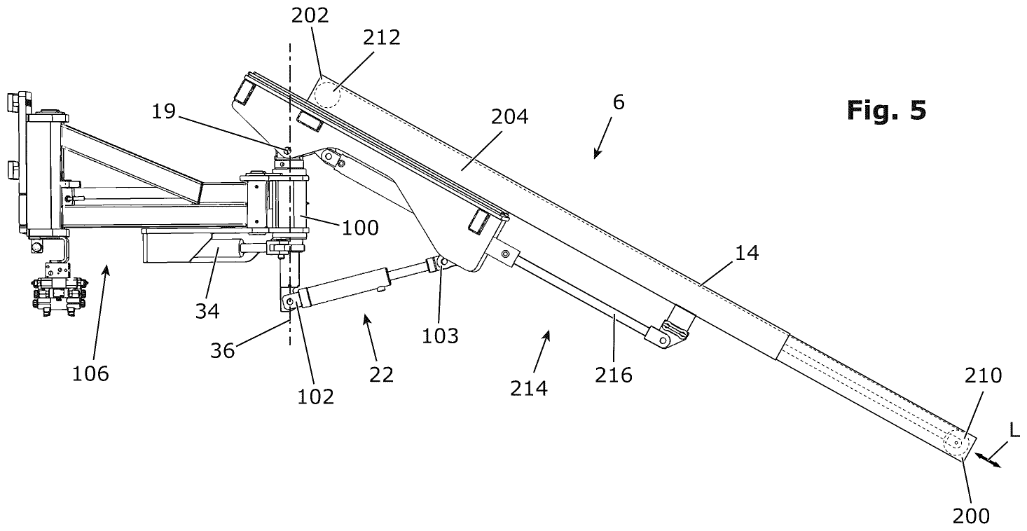

The second adjustment actuator 218 may be arranged and designed in such a manner that the spacing between the first return roller 210 on the first end 200 and the second return roller 212 on the second end 202 is adjustable by means of the second adjustment actuator 218. FIG. 5 depicts the embodiment according to FIG. 4, in which the spacing between the first return roller 210 on the first end 200 and the second return roller 212 on the second end 202 has been adjusted by means of the second adjustment actuator 218.

Two different adjustment operations may be performed by means of the adjustment device 214. On the one hand, it is possible to adjust the belt conveyor base 204 in the longitudinal direction L of the belt conveyor device 6 relative to the machine frame 2. On the other hand, it is possible to adjust the spacing between the first and second return rollers 210, 212. The transport length of the belt conveyor 6 may be adjusted by means of the spacing between the first return roller 210 and the second return roller 212.

It is thus possible, on the one hand, to adjust the belt conveyor base 204 relative to the machine frame 2 by means of the adjustment device 214 and, on the other hand, to adjust the transport length of the belt conveyor 6 by means of the adjustment device 214.

As a result, it is possible to adjust the first end 200 of the belt conveyor device 6 and the second end 202 of the belt conveyor device 6. The first end 200 and the second end 202 may be adjusted independently of each other.

The first return roller 210 and/or the second return roller 212 may be adjusted relative to the belt conveyor base 204. In an embodiment not shown, the adjustment device 214 may also comprise only one adjustment actuator. In this case, the belt conveyor base 204 could first be adjusted by means of the adjustment actuator, which could, for example, be the adjustment actuator 216. To this end, the possibility of adjusting the spacing between the first and second return rollers 210, 212 could be locked, and only the belt conveyor base 204 could be adjusted by means of the adjustment device 214. On the other hand, the belt conveyor base 204 could be locked relative to the machine frame 2 and, with the belt conveyor base 204 locked, the one actuator of the adjustment device could then only be used to adjust at least one return roller.

This would enable both adjustment operations to be performed with a single adjustment actuator, namely, on the one hand, the adjustment of the belt conveyor base 204 relative to the machine frame 2 and, on the other hand, the adjustment of the spacing between the first and second return rollers 210, 212.

In a further embodiment not shown, the adjustment device 214 could comprise two adjustment actuators, each of which may adjust the first and second ends relative to the belt conveyor base, wherein the belt conveyor base is not adjusted in the longitudinal direction of the belt conveyor device relative to the machine frame. The adjustment device may thus also adjust the first and second ends.

At least one return roller may be driven. This could, for example, be the return roller 212. Said return roller 212 may then drive the belt conveyor 6, so that it revolves around the return rollers 210, 212.

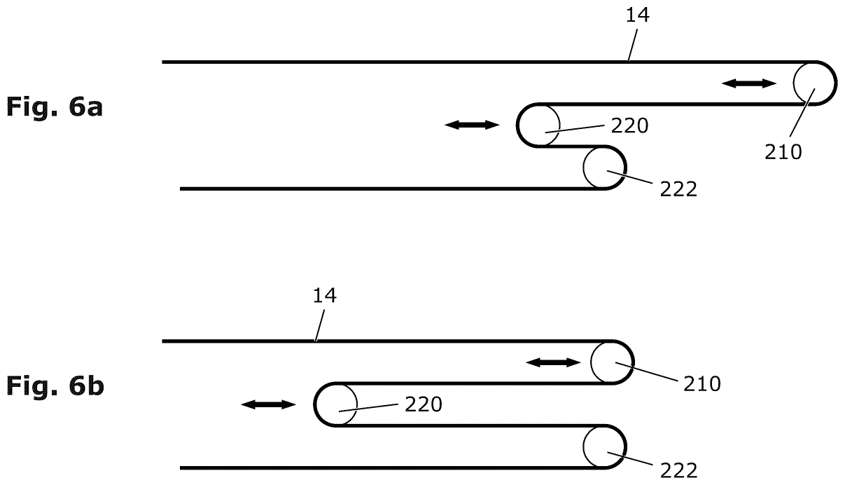

FIGS. 6a, 6b, 7 and 8 show an adjustment of the belt conveyor device 6. The belt conveyor device 6 is depicted only schematically in this arrangement. Furthermore, only the first side 200 of the belt conveyor device 6 is shown. Furthermore, only the belt conveyor 14 and a part of the return rollers are depicted. Everything else has been omitted for the purpose of simplicity. On the first side 200, the belt conveyor 14 revolves around the first return roller 210. The return roller may be adjusted by means of the adjustment actuator 218 depicted in FIGS. 3 to 5. This enables the spacing between the first return roller 210 and the second return roller 212, which is not shown in FIGS. 6a to 8, to be adjusted. This alters the transport length of the belt conveyor, which extends between the first and second return rollers 210, 212.

Furthermore, a third return roller 220 and a fourth return roller 222 may be provided as shown in FIGS. 6a, 6b, 7 and 8. If the first return roller 210 is moved by means of the adjustment actuator 218 depicted in FIGS. 3 to 5, the third return roller 220 may also be moved, namely by such an amount that the belt conveyor 14 always exhibits the same tension. Provided that the first return roller 210 is moved relative to the second return roller 212, namely by an amount X, the third return roller 220 may be moved by the same amount X in the same direction. It can thus be ensured that the belt conveyor 14 always revolves around the return rollers with essentially the same tension.

FIG. 6b depicts the embodiment according to FIG. 6a, merely with an adjusted first return roller 210 and therefore also adjusted third return roller 220. The transport length of the belt conveyor 14, which essentially corresponds to the spacing between the first and second return rollers 210, 212, was decreased in FIG. 6b. The third return roller 220 was adjusted in such a manner that the tension of the belt conveyor 14 remains essentially the same. The length of the path that the belt conveyor 14 needs to revolve around always remains essentially constant. An essentially constant length of the path that the belt conveyor needs to revolve around preferably results in an essentially constant tension of the belt conveyor 6. An essentially constant tension for the purposes of the present application means that the tension is maintained at least to such a degree that the function of the belt conveyor is not impaired. This means that the belt is still capable of conveying material in any adjustment position and, in particular, there is no slip of the drive rollers in relation to the belt conveyor.

A further adjustment actuator may be provided for adjusting the third return roller 220, or the first adjustment actuator may also be used, for example, by coupling the third return roller mechanically to the first return roller 210. The fourth return roller 222 is not adjusted relative to the belt conveyor base. The positions of the third and fourth return rollers 220, 222 may, of course, vary. The positions of the third and fourth return rollers may even be exchanged, provided that it is ensured that the third return roller 220 is moved in such a manner that the tension of the belt conveyor 14 remains essentially constant. In an alternative embodiment, both the third and fourth return rollers may also be moved, wherein the two return rollers are then moved in such a manner that the tension of the belt conveyor remains essentially the same. In such an embodiment, when adjusting the first return roller 210 by the amount X, the third return roller 220 could, for example, be moved by the amount X/2 in the same direction as the first return roller 210, and the fourth return roller 222 by the amount X/2 in the direction opposite to the first return roller 210 and third return roller 220.

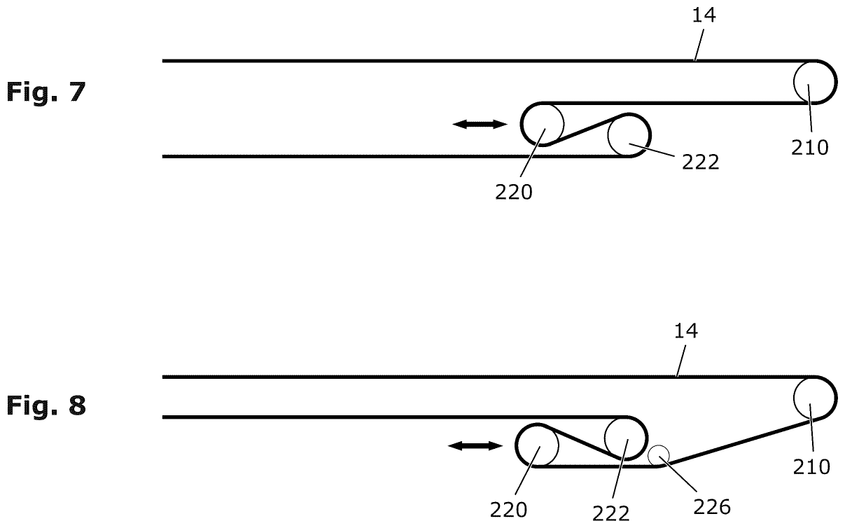

FIG. 7 shows an alternative embodiment of FIG. 6. However, the principle is the same as that in FIG. 6. The return roller 220 is the third return roller, which is also moved when the first return roller 210 is moved. The embodiment depicted in FIG. 7 merely requires slightly less space.

The embodiment according to FIG. 8 works on a similar principle as the embodiments shown in FIGS. 6 and 7. However, the third return roller 220 is arranged differently. The revolving belt conveyor 14 is first guided around a supporting roller 226 and then revolves around the third return roller 220 and then the fourth return roller 222. Also in this embodiment, the third return roller 220 may be moved by the same amount as the first return roller 210.

Alternatively, instead of the first return roller 210, the second return roller 212 may be provided with kinematics corresponding to the embodiments according to FIGS. 6a, 6b, 7, 8.

Furthermore, it is also possible that both the first return roller 210 and the second return roller 212 are moved relative to the belt conveyor base 204. In this case, the third return roller 220 must be moved by the amount by which the spacing between the first and second return rollers 210, 212 increases or decreases. Provided that the first and second return rollers 210, 212 are moved relative to the belt conveyor base 204, it could also happen that the first and second return rollers 210, 212 are adjusted by the amount in the same direction. In this case, there would be no need to adjust the third return roller 220.

As a matter of principle, it is also possible to move both the first return roller 210 as well as the second return roller 212 relative to the belt conveyor base 204 and to provide own kinematics for both return rollers 210 and 212 according to FIGS. 6, 7 and 8.

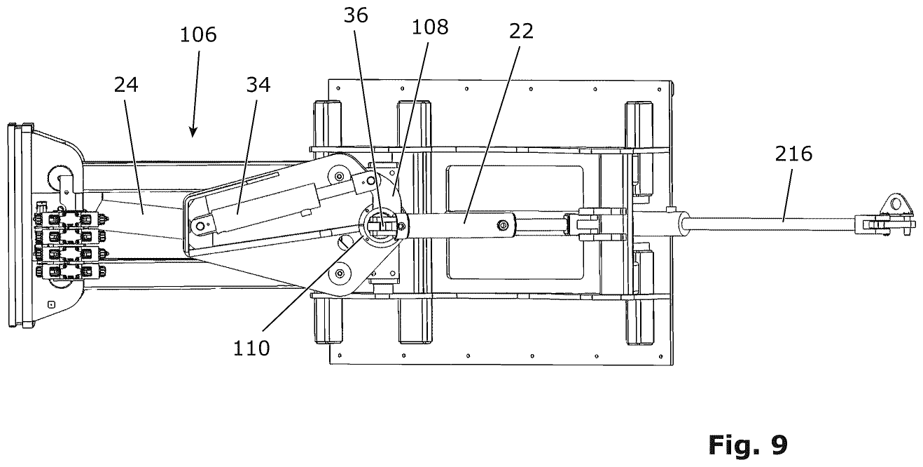

FIG. 9 shows a view of the suspension of the belt conveyor device 6 from below. However, the belt conveyor device 6 itself is not depicted for reasons of clarity. The view depicts the at least one first actuator 22 and the at least one second actuator 34. The first adjustment actuator 216 of the adjustment device 214 can furthermore also be seen.

The second actuator 34 may pivot the belt conveyor device 6 about the vertical pivoting axis 36. The pivoting axis 36 preferably intersects the belt conveyor 14. Furthermore, the pivoting axis 36 may extend through the pivoting axis 19. This can also be inferred from FIG. 4. In the embodiment depicted, the second actuator 34 is connected, on a first side, to a parallelogram guide 106. On a second side, the second actuator 34 is connected in a pivotable manner to a connecting link 108, which is in turn connected to a hollow column 110, which is connected to the belt conveyor device 6. By operating and extending or retracting the second actuator 34, respectively, the hollow column 110, and therefore the conveying device 6, may be pivoted about the pivoting axis 36, and therefore about a vertical axis.

Furthermore, an optional additional actuator 24 is also depicted in FIG. 9. It can be used to adjust the entire belt conveyor device 6 with the parallelogram guide 106. The parallelogram guide 106 is arranged on the machine frame 2.

If the machine does not comprise the optional additional actuator 24 and the parallelogram guide 106, the axis 36 may also be arranged on the machine frame.

Horizontal within the meaning of the present disclosure does not necessarily mean horizontal relative to the ground surface but horizontal to a plane defined by the longitudinal and transverse axis of the machine frame. Vertical means vertical relative to the plane defined by the longitudinal and transverse axes of the machine frame.

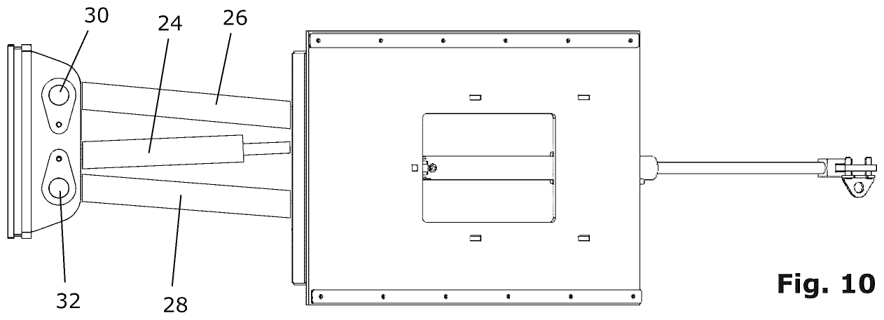

FIG. 10 shows a top view of the suspension of the belt conveyor device 6, however, the belt conveyor device 6 is not depicted for reasons of clarity. Said top view depicts the optional additional actuator 24. Said additional actuator 24 may pivot the entire belt conveyor device 6 in parallel. In the present embodiment, the optional additional actuator 24 pivots the belt conveyor device 6 by means of the parallelogram guide 106. In FIG. 10, the two links 26 and 28 are depicted, each of which pivots about an axis of rotation 30 and 32, respectively.

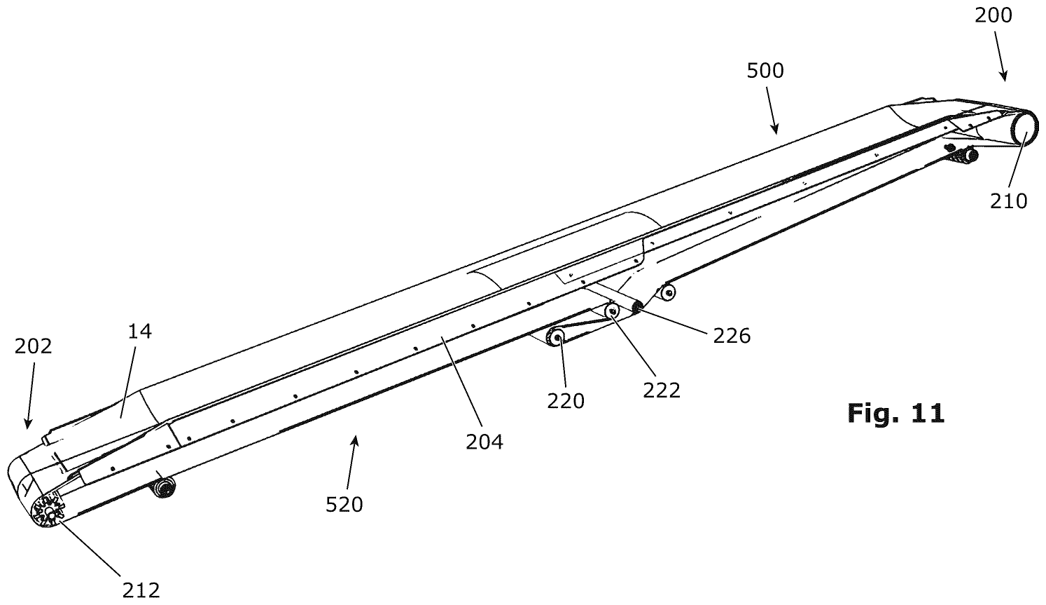

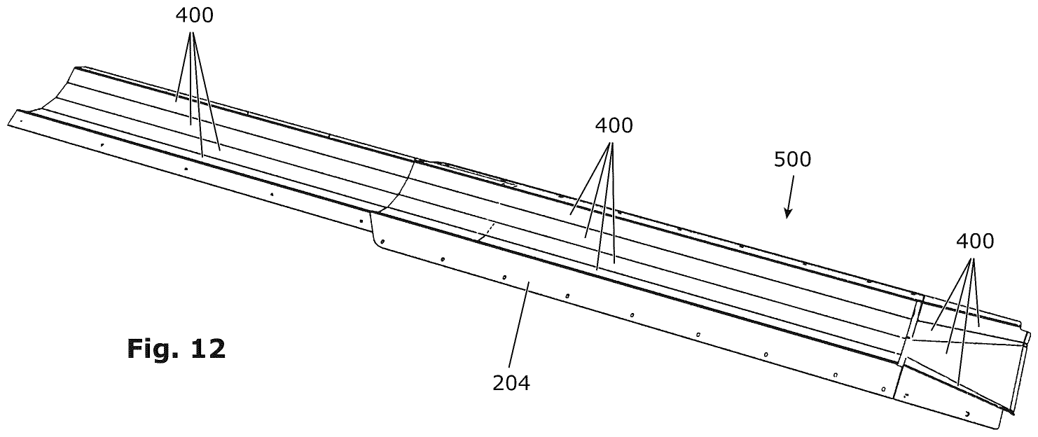

FIG. 11 shows a perspective view of the belt conveyor device 6 without suspension. FIG. 11 depicts the belt conveyor 14, the belt conveyor base 204, the first and second ends 200, 202 as well as the first, second, third and fourth return rollers 210, 212, 220, 222.

The kinematics corresponds to the design according to the embodiment shown in FIG. 8.

As depicted in FIG. 11, the belt conveyor may comprise an upper run 500 and a lower run 520. The upper run 500 may also be termed load run. This is the upper part of the belt conveyor 14, on which the material to be transported lies. It moves from the loading point to the unloading point and carries the load of the material. As depicted in FIG. 12, the upper run 500 is preferably supported by a series of supporting surfaces or bearing surfaces, which ensure that the belt does not sag under the load of the material. Alternatively, the belt conveyor 14 may also be supported by supporting rollers in lieu of supporting surfaces. FIG. 12 depicts the embodiment according to FIG. 11, but without the belt conveyor 14.

The lower run 520, which is also termed empty run, is the lower part of the belt conveyor 14, which runs back to the loading point after the material has been discharged. It carries no load other than the belt's own weight and any remnants of transported material that have not been discharged. The at least one third and at least one fourth return rollers are preferably arranged on the lower run 520.

1-15. (cancelled)

16. A slipform paver, comprising:
at least one machine frame;
at least three traveling devices connected to the machine frame;
at least one belt conveyor device connected to the machine frame such that the belt conveyor device is pivotable relative to the machine frame at least about an essentially horizonal axis and at least about an essentially vertical axis, the belt conveyor device including:
a first end and a second end;
a belt conveyor base;
a belt conveyor arranged on the belt conveyor base;
a first return roller located on the first end; and
a second return roller located on the second end;
wherein the conveyor revolves around the first return roller and the second return roller;
at least one first actuator configured to pivot the belt conveyor device about the essentially horizontal axis;
at least one second actuator configured to pivot the belt conveyor device about the essentially vertical axis; and
at least one adjustment device configured such that at least one of the first and second ends of the belt conveyor device is adjustable in a longitudinal direction of the belt conveyor device.

17. The slipform paver of claim 16, wherein:
the adjustment device is configured such that the first and second ends are adjustable independently of each other in the longitudinal direction of the belt conveyor device.

18. The slipform paver of claim 16, wherein:
the adjustment device is configured such that the belt conveyor base is adjustable in the longitudinal direction of the belt conveyor device relative to the machine frame; and
the adjustment device is configured such that a spacing between the first return roller on the first end of the belt conveyor device and the second return roller on the second end of the belt conveyor device is adjustable.

19. The slipform paver of claim 16, wherein:
the adjustment device is configured such that the first return roller and/or the second return roller is adjustable relative to the belt conveyor base so that a spacing between the first return roller and the second return roller is adjustable.

20. The slipform paver of claim 16, wherein:
the adjustment device includes at least one first adjustment actuator and at least one second adjustment actuator.

21. The slipform paver of claim 20, wherein:
the first adjustment actuator is configured such that the belt conveyor base is adjustable in the longitudinal direction of the belt conveyor device relative to the machine frame by action of the first adjustment actuator; and
the second adjustment actuator is configured such that a spacing between the first return roller on the first end of the belt conveyor device and the second return roller on the second end of the belt conveyor device is adjustable by action of the second adjustment actuator.

22. The slipform paver of claim 21, wherein:
the second adjustment actuator is configured such that the first return roller and/or the second return roller is adjustable relative to the belt conveyor base so that a spacing between the first return roller and the second return roller is adjustable.

23. The slipform paver of claim 16, wherein:
at least one of the return rollers is driven so that the belt conveyor revolving around the return rollers is drivable.

24. The slipform paver of claim 16, wherein:
the belt conveyor device further includes at least one third return roller and at least one fourth return roller, the belt conveyor running around the third and fourth return rollers, wherein the third return roller is adjustable such that the belt conveyor always operates under a predetermined tension even when a spacing between the first return roller and the second return roller is adjusted.

25. The slipform paver of claim 16, wherein:
the adjustment device is configured such that a spacing between the first return roller on the first end of the belt conveyor device and the second return roller on the second end of the belt conveyor device is adjustable between a minimum spacing and a maximum spacing, and the maximum spacing is in a range of 130% to 200% of the minimum spacing.

26. The slipform paver of claim 25, wherein:
the maximum spacing is in a range of 140% to 160% of the minimum spacing.

27. The slipform paver of claim 16, wherein:
the belt conveyor device is adjustable in height relative to the machine frame along an essentially vertical axis.

28. The slipform paver of claim 16, further comprising:
a parallelogram guide configured such that the belt conveyor device is movable relative to the machine frame in an essentially horizontal plane by the parallelogram guide.

29. A method of construction of ground pavements or structures with a slipform paver, the slipform paver including at least one machine frame, at least one belt conveyor device connected to the machine frame such that the belt conveyor device is pivotable relative to the machine frame at least about an essentially horizonal axis and at least about an essentially vertical axis, the belt conveyor device including a first end and a second end, a belt conveyor base, a belt conveyor arranged on the belt conveyor base, a first return roller located on the first end, and a second return roller located on the second end, wherein the conveyor revolves around the first return roller and the second return roller, the method comprising:
pivoting the belt conveyor device about the essentially horizontal axis with at least one first actuator;
pivoting the belt conveyor device about the essentially vertical axis with at least one second actuator; and
adjusting at least one of the first and second ends of the belt conveyor device in a longitudinal direction of the belt conveyor device with at least one adjustment device.

30. The method of claim 29, wherein:
the adjusting includes adjusting the first and second ends of the belt conveyor device in the longitudinal direction independently of each other.

31. The method of claim 29, wherein:
the adjusting includes adjusting the first and second ends of the belt conveyor device in the longitudinal direction simultaneously.

32. The method of claim 29, wherein:
the adjusting includes adjusting the first and second ends of the belt conveyor device in the longitudinal direction successively.
